(19) United States
(12) Patent Application Publication
(10) Pub. No.: US 2007/0294229 A1
(43) Pub. Date: Dec. 20, 2007

(54) Chat conversation methods traversing a provisional scaffold of meanings

(75) Inventor: Lawrence Au, Vienna, VA (US)

Correspondence Address: ARENT FOX LLP, 1050 CONNECTICUT AVENUE, N.W., SUITE 400, WASHINGTON, DC, 20036, US

(73) Assignee: Q-Phrase LLC

(21) Appl. No.: 11/806,261

(22) Filed: May 30, 2007

Related U.S. Application Data
(63) Continuation-in-part of application No. 10/329,402, filed on Dec. 27, 2002.
Application No. 10/329,402 is a continuation-in-part of application No. 09/085,830, filed on May 28, 1998, now Pat. No. 6,778,970.
(60) Provisional application No. 60/808,955, filed on May 30, 2006.

(51) Int. Cl. G06F 17/30

(52) U.S. Cl. 707/3; 707/E17.014

(57) ABSTRACT

A method and system for iteratively searching large amounts of data in response to a user request by traversing a conversational scaffold and producing a document set in response to the request, producing category descriptors for the document set, transmitting the category descriptors to a chatterbot response composer for producing a chatterbot response, and providing the response to the user.

### CROSS-REFERENCE TO RELATED APPLICATIONS

This application claims the benefit of U.S. Provisional Application No. 60/808,955 filed May 30, 2006. This application is also a continuation-in-part of U.S. patent application Ser. No. 10/329,402 filed Dec. 27, 2002, which is a continuation-in-part of U.S. patent application Ser. 09/085,830 filed May 28, 1998, now U.S. Pat. No. 6,778,970. The entirety of each of the above applications is incorporated by this reference herein.

### BACKGROUND OF THE INVENTION

Ever since Joseph Weizenbaum created the Eliza chat program in 1964, researchers have shown considerable interest in creating better versions of Eliza's chat-based user interface. Although Eliza is a chat program (interchangeably referred to herein as a chatbot or chatterbot), which only skimmed the surface of conversation, Eliza demonstrates a significant ability to shift the topic of conversation, thus maintaining an entertaining whimsical facade. To do this, Eliza periodically uses coded rules to repeat fragments of the user's input phasing, to give an illusion of understanding what a user has said. For instance, if a user inputs “my mother eats dates” then Eliza might respond, “Who else in your family eats dates?”

While leveraging the ease-of-use and simplicity of Eliza to improve web search and database query user-interfaces, a number of researchers have run head-first into inherent shortcomings of the whimsical conversational rules that Eliza employs. Users of web search and database query applications have little use for whimsy. Instead, such users generally seek specific data, ultimately defined by sets of results, which they would like to access as quickly as possible. On the other hand, a whimsical Eliza conversation can never stay focused on specific data, because it has to shift from topic to topic almost randomly in order to keep generating interesting responses. By injecting sudden whimsical shifts Eliza impedes a user from actually getting the full results they desire, as if Eliza is a dim-witted store clerk who cannot concentrate on what a customer just requested.

Researchers have tempered the whimsical Eliza by combining Eliza with a user profile of collected or presumed user interests, thus anchoring a chat conversation closer to a core set of interests.

In 2000, Ulrich Thiel and Adelheit Stein published a paper titled “Intelligent Ecommerce with Guiding Agents based on Personalized Interaction Tools,” which is incorporated by reference herein in its entirety, describing project COGITO which defines a user profile to drive chatterbot responses. However, by merely tying a chat conversation to a fixed set of interests, this only slightly raises the probability that the conversation would be of interest. The average user of the Web has many, many disparate interests. Chat which randomly flits from one disparate interest to another is still annoying and irrelevant when a user is seeking specific real set of data. Methods using rules and user profiles also have more serious flaws. Often users research new topics on the web, but cannot yet know how to accurately describe those topics. A program which a priori requires users to submit a description of these new topics gets an inaccurate description of new interests from a novice user.

Methods based on rules and profiles will in turn generate flawed responses from those flawed descriptions.

For example, on America Online AOL AIM chat facility, there is a “SmarterChild” chatterbot, which may be found at smarterchild.conversagent.com, and which is incorporated by reference herein in its entirety. As a prelude to chatting, SmarterChild requests a list of interests and other personal data from a user. Having built a user profile from this data, Smarter Child returns to the same interests and personal data over and over in hopes of entertaining people while attempting to identify and show them related advertisements. However the ability of SmarterChild to actually understand user inputs is extremely limited in the nearly the same rule-based ways that Eliza is limited. Consequently most people sooner or later lose interest in chatting with SmarterChild after they sense the shallow rules driving its parrot-like responses.

A conversation with SmarterChild might go like this:

SmarterChild: What may I interest you in?

User: Fish

SmarterChild: You want me to fish?

User: no I want to cook a fish.

SmarterChild: Oh.

User: now

SmarterChild: Now?

User: with breading

SmarterChild: Really? With breading?

User: corn breading

SmarterChild: Why should I?

User: I'm hungry

SmarterChild: Food is great! I like all kinds of food. >>>Thinking 3^{rd} Edition—Sample Fun Offers and get this Popular Book for Free ! {sponsorship}

User: How do you cook sole with breading?

SmarterChild: I don't know.

User: Help me

SmarterChild: 1) Get info such as news, movies or weather 2) Visit my library including Shakespeare, U.S. Geography and world facts 3) Have fun with word scrambles 4) Use Tools like reminders and planner.

To remedy the above limitations of rule-based analysis in chatterbots, deeper semantic analysis has long been suggested by other researchers. Since accurate semantic analysis can be difficult to implement, some researchers have suggested using semantic analysis for non-critical purposes. Examples of noncritical purposes include hints and suggestions made alongside the central chat conversation, as well as hints and suggestions periodically made during the conversations. Such hints and suggestions have been incorporated into chatterbot programs as early as the classic 1977 text adventure game chatterbot called ZORK, which may be found at http://www.ifarchive.org/f-archive/infocom/articles/NZTZorkhistory.txt, and which is incorporated by reference herein in its entirety.

As a non-critical feature of a chatterbot interface, semantic analysis could fail and the conversation could recover, perhaps like Eliza by whimsically changing conversational subjects to continue to hold a user's interest.

Although the incorporation of hints and suggestions into a chatterbot is not novel, some have suggested using traditional database relationship models to concoct hints and suggestions for a chatterbot. For instance, U.S. Pat. No. 6,578,022 issued Jun. 10, 2003, to Foulger, et al., the entirety of which is incorporated by this reference herein, encourages the use of a “suggestion space” consisting of:
“The collection and analysis of meta-data about data in a database along with the knowledge of what end-users are searching for, and the knowledge of historical query analysis can then be used to develop realtime dynamic matches and executable suggestions that will help ensure the best possible matches are being found—that is, connecting the end-user to ‘just the right information’.”

Unfortunately for implementers following Foulger's disclosure, the natural language of general search requests cannot be mapped by mere meta-data about data in a database. A database mapping is entirely insufficient for representing general natural language meanings. The very nature of database relations depends upon a use of a small dictionary of static universe of linguistic concepts in order for those relationships to be valid. Natural language meaning is too large to map via database relations, and even worse for database method practitioners, far from being static, natural language meanings are continuously evolving through conversation.

That evolution tends to violate previously held database relations, so that new meanings of words cannot be described within existing database schema. For instance, during Clinton impeachment proceedings, the meaning of “I did not have sex” was forced by Clinton's arguments to have meanings beyond a usual lexical relationship as it could by expressed by a database relation. Indeed the disparity between Clinton's meaning and the Special Prosecutor's meaning for those words was a major issue in the meaning of the impeachment proceedings. However without understanding Clinton's meaning, a search engine cannot accurately index what Clinton meant. Similarly new and interesting additional meanings are often fundamental to precise meanings people search for on the Internet.

Therefore despite Foulger's use of the term of “real-time dynamic matches” which refers to real-time data, but not real-time meta-data, the “metadata about data in a database” can neither be accurate nor relevant enough to generate more than occasionally useful search tips, if a practitioner implements the disclosure of U.S. Pat. No. 6,578,022.

The disclosure of U.S. Pat. No. 6,578,022 further emphases static structuring techniques for generating “search tips”: “Standard conceptual taxonomy searching techniques are used to find documents”

Unfortunately for practitioners of Foulger's static methods, the dynamic nature of language rules out any hope that the semantic vocabulary of the Web could ever be mapped by either data-base meta data or by standard conceptual taxonomies. As a result, search tips as disclosed by U.S. Pat. No. 6,578,022 would only occasionally be useful to general users of web search engines.

Other researchers have advocated use of a “metareasoning module” to compose “actual natural language query results”. Variations on metareasoning have been published for many decades, during which time the term has come to include reasoning with probability, neural networks, fuzzy logic, rules with keywords and formal grammar. For instance, as far back as 1990, R. A. Morris, P. S. Bodduluri and M. Schneider published a book titled “A Natural Language Interface to an Al development Tool,” the entirety of which is incorporated by this reference herein, about metareasoning.

In 1991, in a paper titled “Principles of Metareasoning,” Russell and Wefald defined a framework by which autonomous agents, such as chatterbots would employ methods of metareasoning to rationally explore “results for search applications.” See section 6.2. of the paper. In section 7, Russell and Wefald outlined the notion of a “complete decision model, by making every aspect of the agent's deliberation recursively open to metareasoning”. The entirety of this paper is incorporated by this reference herein.

In 1996, in the Contents of FQAS'96 Proceedings Jonas Barklund, Pierangelo Dell'Acqua, Stefania Costantini, and Gaetano A. Lanzarone published a paper titled “Multiple metareasoning agents for flexible queryanswering systems,” The entirety of which is incorporated by this reference herein.

And in 1998, David W. Aha, Tucker Maney, and Leonard A. Breslow published a paper titled “Supporting Dialogue Inferencing in Conversational Case-Based Reasoning,” the entirety of which is incorporated by this reference herein, in which metareasoning methods (also described as Case-base reasoning) improved the quality of specific chat conversations.

All the above were published before a patent filing in 2000, which issued as U.S. Pat. No. 6,560,590 to Shwe, et al., the entirety of which is incorporated by this reference herein, described a specific variation on metareasoning methods for computing a response to a chat user input. However, metareasoning does not perform adequately when supporting a chat user interface for general users of web search engines as taught by U.S. Pat. No. 6,560,590. As disclosed by U.S. application Ser. Nos. 10/329,402 and 09/085,830, all metareasoning with probability, neural networks, fuzzy logic, keywords, formal grammar has severe accuracy and coverage limitations when attempting to handle the dynamic natural of natural language. Metareasoning methods have proven to be remarkably stilted and limited when employed to map the deeper and true meaning of natural language. From the viewpoint of commercial value, inherent problems with metareasoning methods for mapping natural language meaning have constrained commercial metareasoning implementations to narrowly defined specific sub-languages of natural language, such as searching for bank telexes or searching for motor vehicle registrations. General purpose search engines which successfully search the entire web on the other hand have continued to be dominated by direct keyword searching methods, which despite semantic flaws is less stilted and gives wider coverage than methods using reasoning with probability, neural networks, fuzzy logic and formal grammar.

Therefore, any success at employing natural language chat interfaces for general purpose searching has to come from non-metareasoning methods, in particular non-metareasoning methods which explicitly handle in real-time the shifting and reconnection of meanings attached to natural language symbols. This is because the very act of using a general purpose search engine implies some degree of unfamiliarity with how to describe what one is searching for. For example, a user unfamiliar with a scientific field may employ a number of novice's terms to obliquely refer to a scientific idea. For instance, a novice might refer to time dilation in Einstein's General Theory Of Relativity as the “reverse aging of the astronaut.” Any search engine service hoping connect a novice to desirable ideas unfamiliar to the novice has to correlate a number of oblique and even incorrect descriptors to close in on the desired idea. Teachers of students are familiar with that conversational process. It involves a discourse wherein the student's input and misconceptions and descriptive errors serve as a provisional scaffold of meanings for reaching an implicitly desired idea. While allowing and working with peculiarities of a student's input, teachers also direct such a discourse to the most desirable ideas corresponding to the student's input. Thus through discourse, teachers provide responses workable within that provisional scaffold to guide the students toward a conversationally implicit desirable idea. In order to be effective, any natural language search engine interface to accomplish the same has to provide some kind of discourse centered around refining a provisional scaffold of meanings toward a conversationally implicit desirable idea.

### BRIEF SUMMARY OF THE INVENTION

U. S. patent application Ser. No. 10/329,402 discloses how to identify the deeper semantic meaning of requests via chatterbot, using discourse centered around refining a provisional scaffold of meanings to guide users toward a conversationally implicit desirable idea.

By replacing metareasoning with more flexible and dynamic methods to map search requests to actual semantic meanings, a provisional scaffold of meanings can be mapped from user requests to guide users toward conversationally implicit desirable search results. Since users often will not know the most effective terms for specifying search results, a chatterbot must semantically map all user requests into a provisional scaffold of meanings optimized for semantic relevance.

In order to overcome pitfalls inherent to probability calculations and static semantic-hierarchic reasoning, such a chatterbot must deviate from traditional metareasoning methods. Only when chatterbot methods are freed from problems caused by statistical sampling and out-of-date semantics can a balanced and up-to-date mapping of search requests be calculated to create a provisional scaffold of meanings optimized for semantic relevance.

A full chat interaction between user and computer typically requires a number of exchanges before a user is fully satisfied. By characterizing those exchanges in terms of provisional scaffold of meanings, a chatterbot can more effectively guide a conversation to directly elicit enough natural language meaning to define and retrieve a full and accurate set of results.

Methods of characterizing chat exchanges in terms of natural language meaning; are fundamentally different from characterizing them in terms of either database relations, probability relations or fuzzy-logic relations. Since chat effectively forms new meanings on-the-fly, as disclosed by U.S. patent application Ser. No. 10/329,402, proper characterization of chat exchanges has to continuously and on-the-fly form new semantic hierarchies, none of which can be covered by traditional static hierarchic methods.

While implementing a semantic chatterbot, commercial chatterbots also need to encourage efficient conversations. Search engine portals cost significant money to host, and portals hosting a semantic chatterbot can consume expensive computer resources when searching a large dictionary for semantically relevant meanings. Therefore practical implementations of a true semantic chatterbot often need to efficiently guide a conversation to fruition rather than allow it to wander as Eliza does. The present invention not only guides conversation from the beginning, it continues to calculate and update optimal responses for guiding the conversation at nearly every conversational exchange.

For instance, to efficiently lead the beginning of a chat conversation, the chatterbot can start the conversation with “What to you wish to find?” This provides a semantic framework to encourage the user to describe something sought, thus creating a natural language query. The users' response can then be treated as a natural language query which then can be parsed and fed to an index to search the Web for relevant results.

Typical natural language queries are somewhat ambiguous. In addition, many natural language queries contain mood establishing phrases such as “I'm looking for” and “anything about” which can be mostly ignored unless they contain a strong emotional overtone.

For instance, given the natural language query “I'm looking for cars” a natural language parser could ignore “I'm looking for” to reduce the query to “cars”. The chatterbot would then input the query “cars” to a keyword or semantic index, which could then return a large Document Set of web page; results describing various aspects of cars.

The methods of U.S. application Ser. No. 10/329,402 can be used to dynamically and automatic classify Document Set results into a small number of newly defined categories, which can then presented to the user as a list of suggestions. Alternatively, other less powerful and less accurate methods such as statistics might be used to automatically classify results.

For instance, results from “cars” might be dynamically categorized as new cars”, “used cars”, “rental cars” and “concept cars”. The present invention would then concatenate that list into a new leading question: “Are you interested in new cars, used cars, rental cars or concept cars?”

The present invention could employ an automatic statistical classifier instead of a classifier using semantic and topological methods. However, because of the inability of statistical methods to detect true semantic meanings, an automatic statistical classifier is typically unable to define a compact set of categories. For instance, a large Document Set for “cars” might be poorly categorized as “best prices” “best quality”, “Ford” and “Chevrolet parts”. These results from a statistical classifier could still be concatenated into somewhat useful but much less intelligent leading question: “Are you interested in best prices, best quality, Ford or Chevrolet parts?” The poor quality of a statistical categorizer would lead to a longer and more circuitous conversation before closing in on the users' desired topic, just as a dim-witted store-clerk might take a long time to understand a customer's desire.

Having seen or heard how a chatterbot responds with a question about categories of the user's request, the user then sees some examples of the ambiguity of “cars”. And at this point, the user can input a natural language comment about that ambiguity. Such a comment typically steers the conversation in one of a few useful directions. Using a provisional scaffold of meanings constructed from output of an automatic categorizer together with chat conversation words, the present invention provides methods to traverse toward a useful directive the user has in implied. For instance, by detecting semantic characteristics of the user's reply relative to the semantics returned by the automatic classifier, a precise user directive can be computed. The semantic results from any automatic text classifier generally contains categories and terms associated with each category. As Wanda Pratt wrote in 1999 in “Dynamic Categorization: A Method for Decreasing Information Overload”:
“For this type of clustering application, the systems also need a way to describe each cluster to the user. They usually label each cluster using the highest-weighted terms from the center of that cluster.”

Such highest-weighted terms, or any terms associated with a category can be mapped to see if the user's response corresponds to any of them, either in exact spelling, or related through morphology, or related through similarity of meaning (as a synonym) or related as contextually related term via a taxonomy which may be static or generated dynamically by the automatic classifier. Even more comprehensive and dynamic mappings can be computed using the methods of U.S. application Ser. No. 10/329,402.

It could be that the user responds with a term which cannot be associated with any suggested category. If this is the case, this unassociated term can be considered extra semantics needing to be queried in conjunction with the earlier query. For instance, for an initial query of “plum” suggested categories might be “plum island”, “plum business services”, “plum book”. The chatterbot response would be “Are you interested in plum island, plum business services, or plum book?” A user response might be an unassociated term “recipe”. By combining “plum” with “recipe” to query “plum recipe” a new set of results closer to the user's intention would return from the index. This new set of results can be automatically categorized into “plum wine”, “plum sauce” and “plum tea”. The focus of the conversation is now much more specific, and closer to what the user implicitly desires. By conversing this way, the chatterbot can continuously close in on specifics until the conversation is focused on only a few individual web sites whose glosses can be read to the user over a chat or cellphone interface. This method of focusing on ever more specific terms is called a “chat drill-combination”.

However if a user responds with a term which can indeed be associated with a single category, the user is directing the conversation toward that single category and away from the other categories. Even if the user responds with a term associated more with some categories than others, the user is directing the conversation away from the other categories in a relative way. As a result, a chatterbot can best serve such a directive by speaking to subcategories most closely related to the user designated category or categories. By instructing the automatic categorizer to analyze only data most closely related to the designated category or categories, a new set of categories will emerge with far greater relevancy to the user's directive. The chatterbot can respond with a new question concatenated from these new categories. For instance, user may have responded to “Are you interested in new cars, used cars, rental cars or concept cars?” with “Rental” which would correspond to “rental cars”. The automatic categorizer might then return categories of “vacation rental” “daily rental” and “weekly rental”. The chatterbot would then concatenate these new categories into a new response question such as: “Are you more interested in vacation rental, daily or weekly rental?”

The focus of the conversation is again now more specific. Again by continuing to converse this way, the chatterbot can close in on specifics until the conversation is focused on only a few individual web sites whose glosses can be read to the user over a chat or cellphone interface. This method of focusing on ever more specific terms is called a “chat drill-into”. Even if a user responds with a simple “yes” or “OK” this can be considered affirmation that all suggested categories are of interest. Consequently the chatterbot can select a subset of results closest to all suggested categories, and re-categorize only that subset.

However if the user responded with a negative comment such as “no rental”, this could be considered negation of a specific concept, as disclosed by U.S. patent application Ser. No. 10/329,402. Or a negative reply could be detected with a cruder less accurate method, such as list of keywords such as “no”, “not” and “never”. Regardless, the detection of a negative reply can be interpreted as meaning that none of the negated categories sound desirable to the user.

Often a negative reply is a symptom that the user has a different mental taxonomy than the automatically generated taxonomy. However even a different mental taxonomy often shares other categorical terms, which can be just under the surface of the last chatterbot reply. Therefore the chatterbot can remove all the undesirable categories by directing the automatic categorizer to reject them and produce a new set of categories within the context of that rejection. If the user responds “no” outright, then all the categories of the last chatterbot response can be rejected. If just one or two are associated with the reply, just one or two rejected. This method of focusing away from inhibited terms is called chat drill-away”.

However if the user responds with an emotionally laden reply, generally the user desires an immediate shift in topic, beyond the reach of any topics within the Document Set. Responses such as “What do you mean?” and “Why would I want to rent a car?” demonstrate directives beyond the meaning of categories automatically distilled from a “cars” Documents Set. Rather, such emotional responses much be met by associating them with deeper story patterns occurring in natural conversation. These deeper story patterns and their associated emotional paths through emotional shifts can be tracked and mapped by the disclosure of U.S. patent application Ser. No. 09/085,830. Appropriate responses for explaining and diffusing user impatience can be chosen from stories with similar emotional paths, which led to user satisfaction. For instance, selecting from such a story, a chatterbot could reply, “Some people find rentals convenient for temporary needs.” This method of conversationally shifting a topic is called “chat emotional balancing.”

In summary, the present invention discloses five examples of methods for traversing predominant possible conversational directives for search and for maintaining a provisional scaffold of meanings related to a chatterbot conversation:

1) user wants to know about query request, such as “cars”: query the index and categorize results (chat initiation),

2) user wants to know about “cars” in addition to something the categorizer cannot map to “cars”, such as “aluminum”: combines “aluminum” and “cars” into “aluminum cars” and re-query the index and categorize new results (chat drill-combination),

3) user likes categories suggested for “cars” so select results closest to the suggested categories and categorize only these selected results (chat drill-into),

4) user dislikes a category or categories suggested for cars so inhibit categorizer from forming categories around them, re-categorizing around the other terms (chat drill-away),

5) user request something which does not fall into the above categories, so compute the emotional path of the user request and reply with a selection from the story having the most similar emotional path leading to a desirable story plot (chat emotional balancing).

For any given user response, the present invention may traverse to one or more of the above directives before fully computing the next chatterbot response. For instance, a user response may contain both positive and negative directives at once. A user response of “Not rental but hybrid cars” would invoke both a chat drill-away for “rental” and either a chat drill-into or a chat drill-combination for “hybrid”, all of which can be computed before issuing the next chatterbot response.

### BRIEF DESCRIPTION OF THE DRAWINGS

FIG. 1 shows main elements of a chatterbot traversing a provisional scaffold of meanings, in a flowchart of processing between automatic categorizer, web index, and chatterbot user interface, directing processing based upon user directives to deliver desired search results to a user.

FIG. 2 shows an example of an initial conversation with a categorization enabled chatterbot.

FIG. 3 shows an example of a developing conversation with a categorization enabled chatterbot.

FIG. 4 shows an example of a further developing conversation with a categorization enabled chatterbot.

FIG. 5 shows an example of a chatterbot user interface using a cellphone voice input and speech synthesis instead of a graphical interface.

FIG. 6 shows a flowchart of a method to enhance the chatterbot of FIG. 1 with a telephonic interface to users.

FIG. 7 shows a method of tracking conversational shifts in emotional feeling in a four-dimensional space, in accordance with one embodiment of the present invention.

FIG. 8 shows a flowchart of a method of using the detection of conversational shifts to balance conversational feelings, in accordance with one embodiment of the present invention.

FIG. 9 presents an exemplary system diagram of various hardware components and other features, for use in accordance with an embodiment of the present invention.

FIG. 10 is a block diagram of various exemplary system components, in accordance with an embodiment of the present invention.

### DETAILED DESCRIPTION OF THE INVENTION

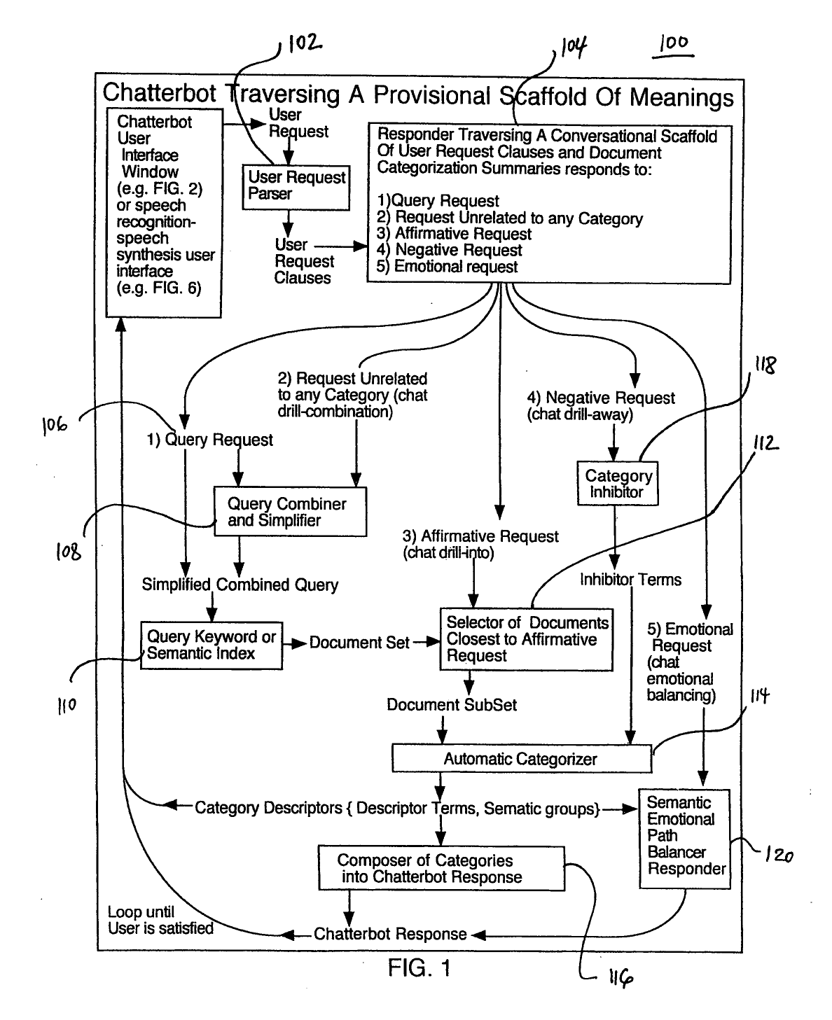

Using a standard chat user interface for input from a user and output to a user, or alternatively a speech recognition system for input from a user and speech synthesis for output to a user via a telephone or mobile phone (interchangeably referred to herein as a cellphone) interface, as described in, for example, in U.S. patent application Ser. No. 10/329,402, the flowchart in FIG. 1 shows a method 100 of searching of large data sets such as the world wide web or other large databases, in accordance with one embodiment of the present invention.

A user request is parsed 102 by a User Request Parser into useful clauses marked by negation markers such as “no” and “not” or marked by affirmation markers such as “want,” “need” or “yes.” The parsing of requests into these phrases can be done, for example, via semantic methods disclosed by U.S. patent application Ser. No. 10/329,402, or approximately parsed by cruder keyword, rule and stopword methods. The cruder methods result in less accurate parses, but the semantic methods require more memory and processor power.

The parsed User Request Clauses are passed 104 to a Responder, which determines what computational action to perform on behalf of each User Request Clause. The Responder also recognizes 104 Affirmation and Negative requests by the presence of a semantically contextually significant affirmation such as “yes” or presence of a semantically contextually significant negation such as “no.” The Responder further recognizes 104, an Emotional Request, by the presence of a question mark “?” or questioning, belligerent, or otherwise semantically contextually emotionally laden terms, such as “What do you mean”? or “That's ridiculous.” “The Responder further recognizes 104 any other Query requests as either related or unrelated to the previous chatterbot response, by computing a semantically contextual distance to category summary terms previously presented to the user. As will be readily understood by those of ordinary skill in the art, there is no previous chatterbot response for the initial query, so any other Query request becomes a type 1) Query Request at step 106.

The Query Combiner and Simplifier improves upon direct concatenation of previous Query Request and Request Unrelated to any Category, by eliminating redundant words and putting adjectives first 108. For instance, combining hybrid car and gas/electric car, the Combiner would output, at 108, a Simplified Combined query of hybrid gas/electric car. The Query Combiner and Simplifier also simplifies queries containing gentle mood hints such as “looking for” and “all sorts of,” by ignoring them 108. For instance, “all sorts of RSS feeds” would become “RSS feeds.” The Query Keyword or Semantic Index accepts Combined Query input and outputs Document Set results from a data store, such as a database or other repository of data, 110. The results can be pointers to or internet URL address of documents, paragraphs, sentences, spreadsheets, tables, rows, or any other grouping of data. In the case of a Query Keyword Index, the Document Set is retrieved by keywords in the Simplified Combined Query. Since keyword indices only index on the spelling the keywords, keyword indices will miss Document Set data corresponding to synonyms of words in the Simplified Combined Query, according to one embodiment of the present invention. And since keyword indices do not distinguish between polysemous meanings of spellings, keyword indices will also include unwanted Document Set data, according to one embodiment. For instance, input of a Combined Query of “storage” to a Keyword Index will usually return both documents about self-storage and about computer storage devices, when, in fact, a user generally only intends one of these meanings. Therefore, it is better to use a Query Semantic Index as disclosed, for example, by U.S. patent application Ser. No. 10/329,402, instead of keyword indices.

The Document Set serves as input to the Selector of Documents closest to Affirmative Request. If there is no Affirmative Request, the complete Document Set is selected into the Document Subset 112. On the first conversational chat exchange, in accordance with one embodiment, there can be no Affirmative Request; the Affirmative Request must come from the user within a subsequent user Request. Any Affirmative Request is used to select only the Document Set subset closest in meaning to the Affirmative Request. Fast word matching and morphology can be used to find Documents Set data closest to the Affirmative Request. However, for more accurate results it is better to use semantic distance metrics subject to a cut-off distance as disclosed, for example, by U.S. patent application Ser. No. 10/329,402 to produce Document Subset output.

The Automatic Categorizer takes Document Subset data as input and automatically categorizes 114 that data into major categories labeled by exemplary terms representing those categories. Many automatic categorizers have been built using statistics tempered by stopword lists and guided by static semantic hierarchies. Although such categorizers tend to produce extraneous categories, and long labels with extraneous terms, such categorizers can still provide enough data summarization to enable a chatterbot to function. It is far better, in accordance with one embodiment of the present invention, to automatically categorize data using semantic and topological methods disclosed, for example, by U.S. patent application Ser. No. 10/329,402. By eliminating statistical methods and preventing static hierarchies from forming extraneous categories, semantic and topological methods of categorization produce clearly more relevant categories with terser and pithier category labels.

Nevertheless, most any Automatic Categorizer will produce Document Subset data categorized into a variety of categories 114, which are interchangeably referred to herein as Semantic Groups, with Descriptor Terms as category labels. Among the Descriptor Terms for each category, there is generally a term most preferred for use as a label, and set of less preferred terms. The less preferred terms can be useful in a variety of computations for user-directed re-categorization. Among the Semantic Groups for each category are the locations of examples of usage of Descriptor terms within the Document Subset data, such as documents, URL of documents, paragraphs, sentences, clauses or phrases.

The Composer of categories into Chatterbot Response takes the most preferred term for each category and concatenates the terms into a sentence of question format. For instance, categories of “used cars”, “new cars” and “concept cars” could be composed into “Are you interested in used cars, new cars or concept cars?” or an alternate form “How about used cars, new cars or concept cars?” The tone of the question can be varied by how close the number of categories are to the number of individual web pages results in the Document Set. When closer, the chat conversation has reached a detailed level, and the simpler form “How about used cars, new cars or concept cars?” is more appropriate.

The Composer outputs a chatterbot response 116 to present to the user, either as text in a chatterbot interface, or converted to sound by a speech synthesizer, should the user be interfacing to the chatterbot through a telephone or cellphone interface. The chatterbot then listens for a next User Request. When a next User Request arrives, again the User Request is parsed 102 by the User Request Parser. This time there is possibly a Affirmative Request, a Negative Request, a Request Unrelated to any Category, as well as possibly an Emotional Request. First, the Responder looks for Affirmative or Negative or Emotional Requests 104, since they are marked by words which in the semantic context are affirmative, negative or emotional in meaning. A fast word match and morphology method could be used to find marking words, but semantic and topological methods disclosed by U.S. patent application Ser. No. 10/329,402, for example, are the most accurate way to find marking words, in accordance with one embodiment of the present invention.

If affirmative request clauses are found, non-marker terms within them are used as input to the Selector of Documents Closest to Affirmative Request to produce the new Document Subset 112.

If negative request clauses are found, the Category Inhibitor outputs Inhibitor Terms from the non-marker terms within each Negative Request 118. These Inhibitor Terms then prevent the Automatic Categorizer from forming categories around them. For statistical categorizers, the Inhibitor Terms are used as stopwords. For semantic and topological categorizers, semantic synonyms of the Inhibitor Terms are deprecated from categorization.

If either affirmative or negative request clauses are found, the output of the Automatic Categorizer is again input to the Composer of Categories into Chatterbot Response 116. This Composer then again outputs a Chatterbot Response 116, so the present invention's chatterbot method loops again until the User is satisfied.

If emotional request clauses are found, they are used as input to the Semantic Emotional Path Balancer Responder. This Responder maps deeper story patterns and their associated emotional paths through emotional shifts that can be tracked and mapped by the disclosure of U.S. patent application Ser. No. 09/085,830, for example. Appropriate responses for explaining and diffusing user impatience can be chosen from stories with similar emotional paths, by quoting from a story which led to a satisfaction emotion. For instance, a user might ask “Why are you asking so many questions?” Selecting from such a previously stored story about asking questions, a chatterbot could reply, “I'm trying to help you by understanding what you want.”

As with output from the Composer of Categories into Chatterbot Response, the output from Semantic Emotional Path Balancer Responder is sent to the user 120, so the present invention's chatterbot method loops again until the User is satisfied.

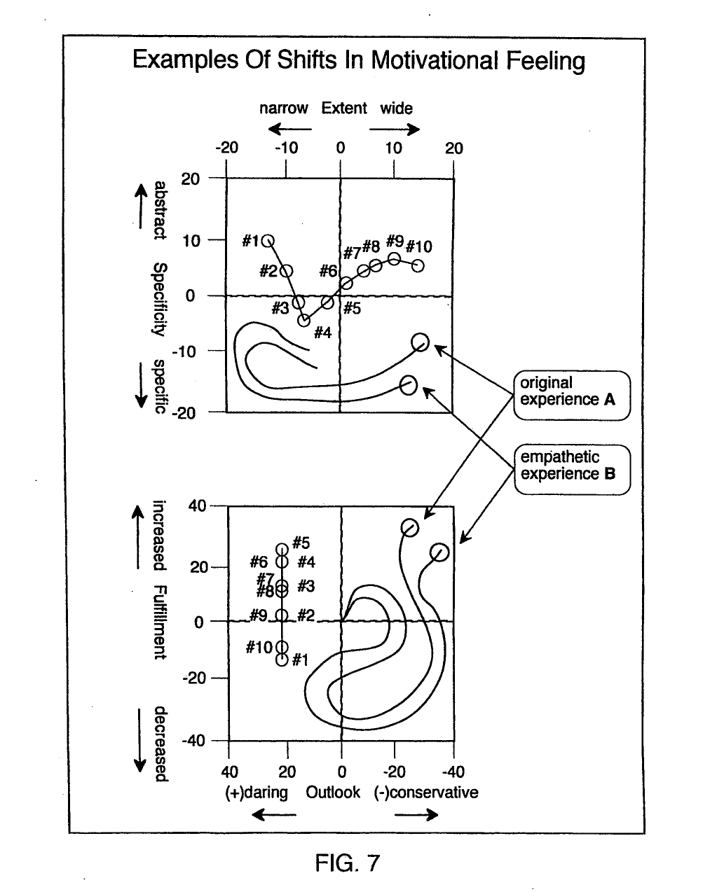

FIG. 7 shows a copy of a drawing (FIG. 87) from U.S. patent application Ser. No. 09/085, 830. This drawing shows a method of tracking conversational shifts in emotional feeling in a four-dimensional space. Two of the dimensions are specificity and extent of semantic network nodes parsed from the conversation. Two of the dimensions are fulfillment and outlook characteristics of the same semantic network nodes parsed from the conversation. Tracking the most recent semantic network nodes parsed from the conversation, the emotional path through the four dimensions can graphed as conversationally sequential points one through ten in FIG. 7. The graph in the upper half of FIG. 7 shows that the conversational path increases in extent of meaning. The graph in the lower half of FIG. 7 shows that the conversational path first increases then decreases in fulfillment.

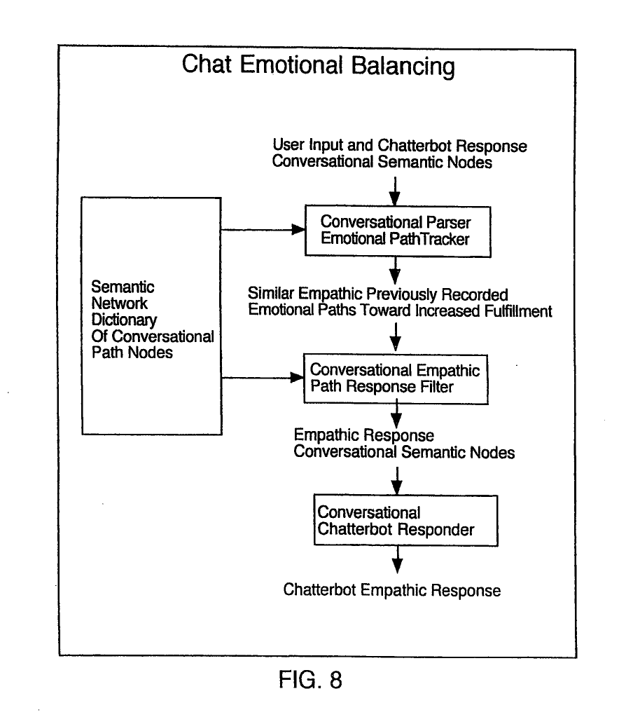

FIG. 8 shows a flowchart of a method of using the detection of conversational shifts from U.S. patent application Ser. No. 09/085,830 to balance conversational feelings. By first collecting and storing a variety of conversations and their underlying semantic network nodes into a large semantic network dictionary, subsequent conversations can be parsed into semantic network nodes to reveal emotional similarities between current and previous conversations. By computing the distance between current and previous conversations in the four-dimensional space, U.S. patent application Ser. No. 09/085,830 shows how to compute empathy by selecting emotionally similar conversational examples from previous conversations. In FIG. 8, the Conversational Parser Emotional Path Tracker performs this task. Rather than just parse a conversation for meaning, the Conversational Parser Emotional Path Tracker parses for emotional content by mapping the semantic nodes in the four dimensions of FIG. 7 and by detecting previously stored conversations with similar paths through those four dimensions. The Conversational Parser Emotional Path Tracker produces output of Similar Empathic Previously Recorded Emotional Paths Towards Increased Fulfillment, the goal being to increase the User's emotional sense of fulfillment. The Conversational Empathic Path Response Filter takes this as input, to determine which parts of the Empathic Previously Recorded Emotional Paths can next be traversed, in terms of actual semantic nodes. These actual semantic nodes are output as Empathic Response Conversational Semantic Nodes. These nodes are input to the! Conversational Chatterbot Responder, which must map the nodes to a coherent response in natural language sentence, by paraphrasing meanings of Empathic Response Conversational Semantic Nodes. The paraphrasing must explain any differences between Empathic Response Conversational Semantic Nodes and nodes already parsed into the conversation, so that the Chatterbot Empathic Response is phrased in terms directly related to terms already in the conversation. For instance, if a users asks “Why are you asking so many questions?” and the Empathic Response Conversational Semantic Nodes are “to help”and “user,” “user” must be paraphrased as “you” to generate the response “to help you.”

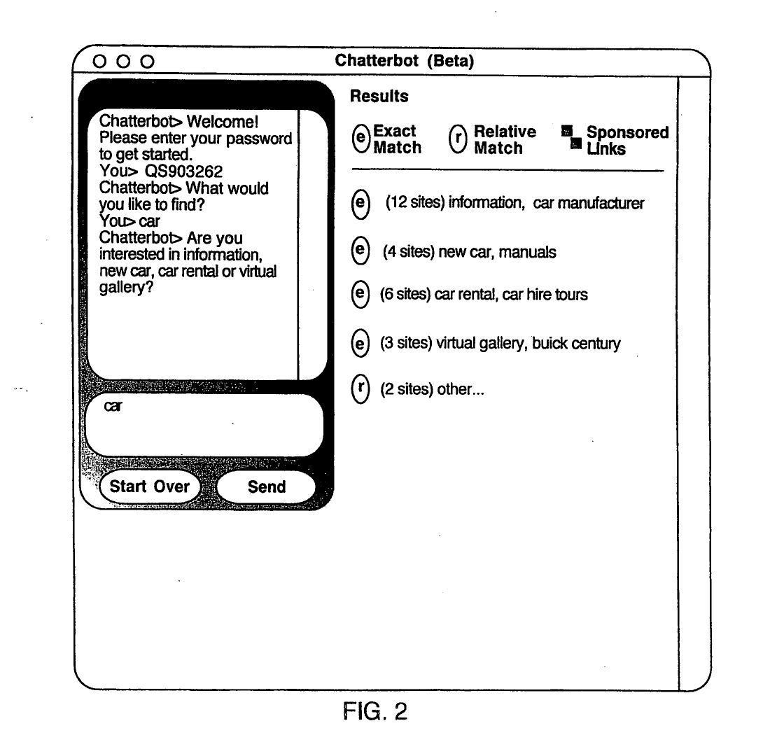

FIG. 2 shows a screen-shot of an example of a web-enabled chatterbot user interface based on the present invention. The left hand side of the user-interface has a popular form of a chat interface, where a top box has a scrolling record of a chat conversation, and a bottom box accepts user input to the chat conversation. Each time a user enters a chat response into the bottom box and presses the Send button, that chat response is sent to a computer running the chatterbot process loop diagramed by FIG. 1. Note that the Start Over button is to the left of the Send button. The Start Over button enables the user to easily start the chat from a fresh start beginning, without logging in, so that chat conversations containing concepts which are not longer of interest can be dropped in favor of a new fresh conversation, taking the conversation to a “chat initiation” direction. Alternatively, an emotionally charged input of “Please start over” could direct’ the Semantic Emotional Path Balancer Responder to in effect press the Start Over button automatically by dropping some or all of provisional scaffold of meanings from the chatterbot's memory.

In the embodiment shown in FIG. 2, the user has logged in using a password, and asked for information about cars. The chatterbot has responded with “Are you interested in information/car manufacturer, new car, tours/car hire or virtual gallery details?” This sentence was concatenated from Category Descriptors which can be seen in the right hand side of user-interface. Note that there is an “other . . . ” category for Document Set data which the Automatic Categorizer could not link to any major category. The Composer of Categories into Chatterbot Response has been coded to ignore the “other . . . ” category.

On the right hand side of the user-interface labeled Results, each major category has an icon with an exemplary designation “e” followed by its main descriptor terms. The letter “e” may refer to an exact category match to a category of “cars.” The “other . . . ” category has an icon with the exemplary designation of “r.” The letter “r” may refer to, for example, a lesser “relative” degree of match to categories of “cars.”

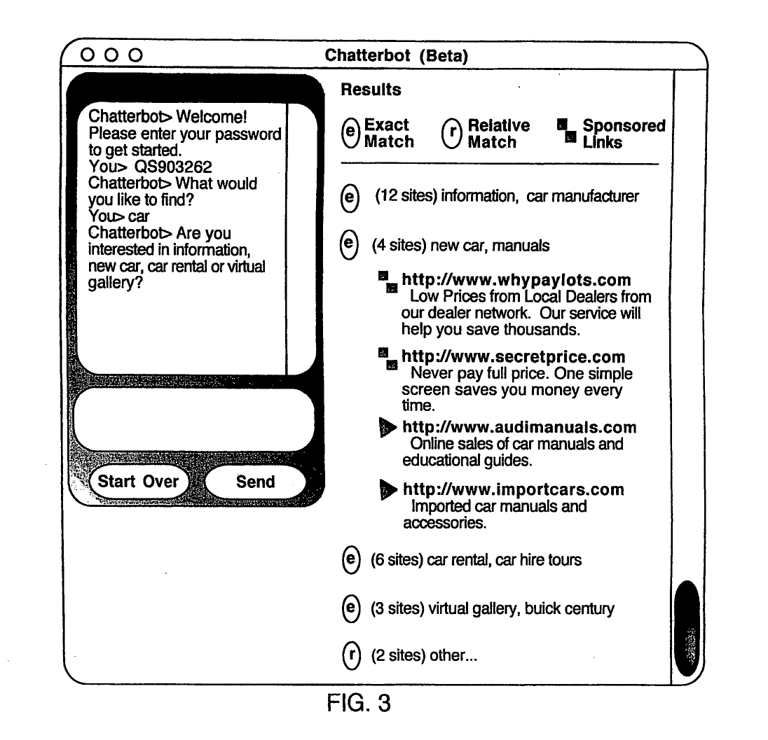

In the embodiment shown in FIG. 3, the user has clicked on the results for the “new car” category of FIG. 2. As would be expected for standard graphical user interfaces, this opens up detail of the “new car” category. In this example, links to web pages are now displayed under the “new car” category header. Sponsored links are denoted by the double-squares icon. Non-sponsored links are denoted by the arrow icon. Each link is described by its web URL and a short blurb of a few sentences. As with most search engine portals, clicking on a link opens up a web browser page displaying the web URL.

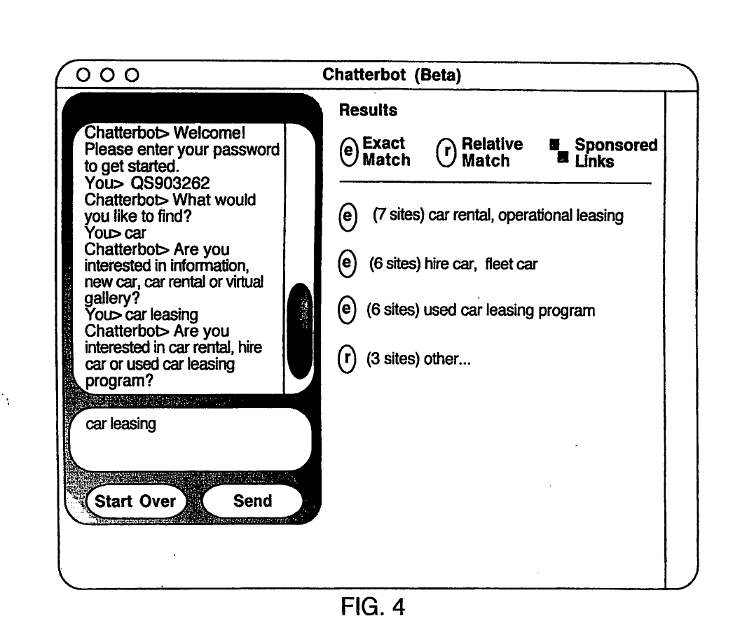

The embodiment of the present invention shown in FIG. 4, shows an example of a chat drill-combination conversation. The user has begun by asking for “car.” The chatterbot has responded with “Are you interested in information/car collector, new car, car rental or virtual gallery details?” The user has responded with “car leasing” which was then combined with “car” to query for “car leasing.” The query of “car leasing” has resulted in a document set which was automatically categorized. The category descriptors were concatenated into the chatterbot response of “Are you interested in car rental, hire car, used car?” which are categories displayed in greater detail on the right hand side of the user interface under Results.

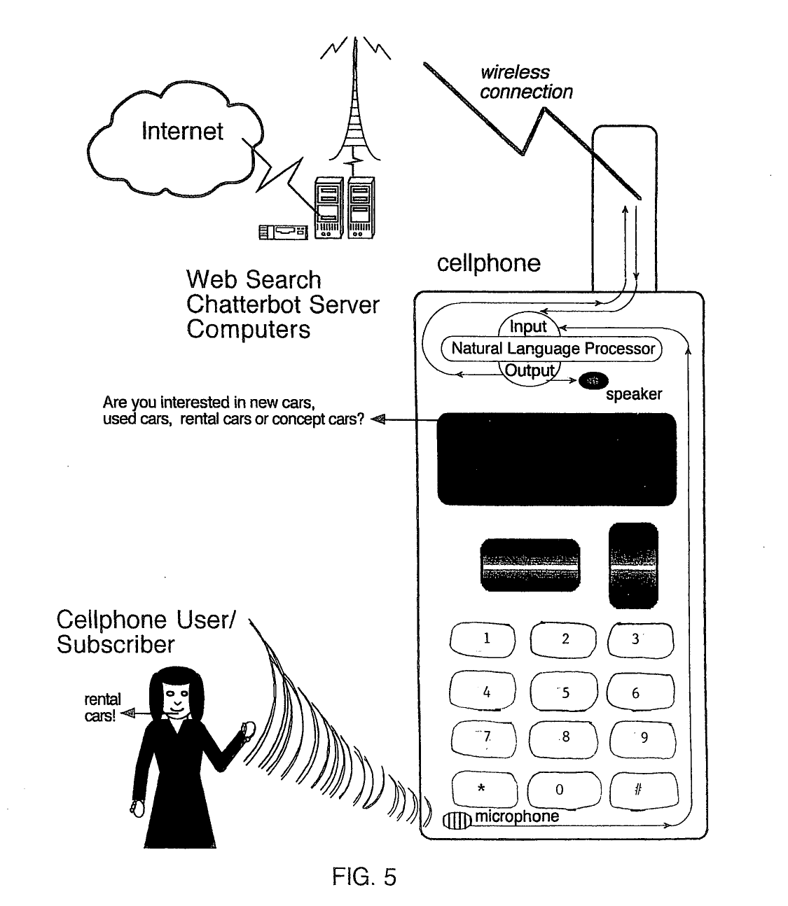

FIG. 5, in accordance with one embodiment, shows an example of a chatterbot user interface using a cellphone voice input and speech synthesis instead of a graphical interface. Here a user has previously input “cars” via the user's cellphone, and the chatterbot methods of the present invention have used speech recognition to pass the word “cars” as input to the method of FIG. 1. The method of FIG. 1 has produced the Chatterbot response of “Are you interested in new cars, used cars, rental cars or concept cars?” which the cellphone has rendered into audible English speech via a speech synthesizer. Upon hearing this, the user says “rental cars!” which is in turn picked up by the cellphone's microphone, converted to the words “rental cars” to be passed as input to the method or FIG. 1, completing a loop through the method of FIG. 1. Note that the semantic distance methods of U.S. patent application Ser. No. 10/329,402 can also be used to more clearly disambiguate speech than a standard statistical speech recognition method, for example, since by using those methods the semantic context of the conversation can be used to increase the weight given to words which are only imperfectly pronounced but conversationally most relevant. Just as people can hear words which are only half-pronounced though clearly relevant, the methods of U.S. patent application Ser. No. 10/329,402 can be used to detect such half-pronounced utterances.

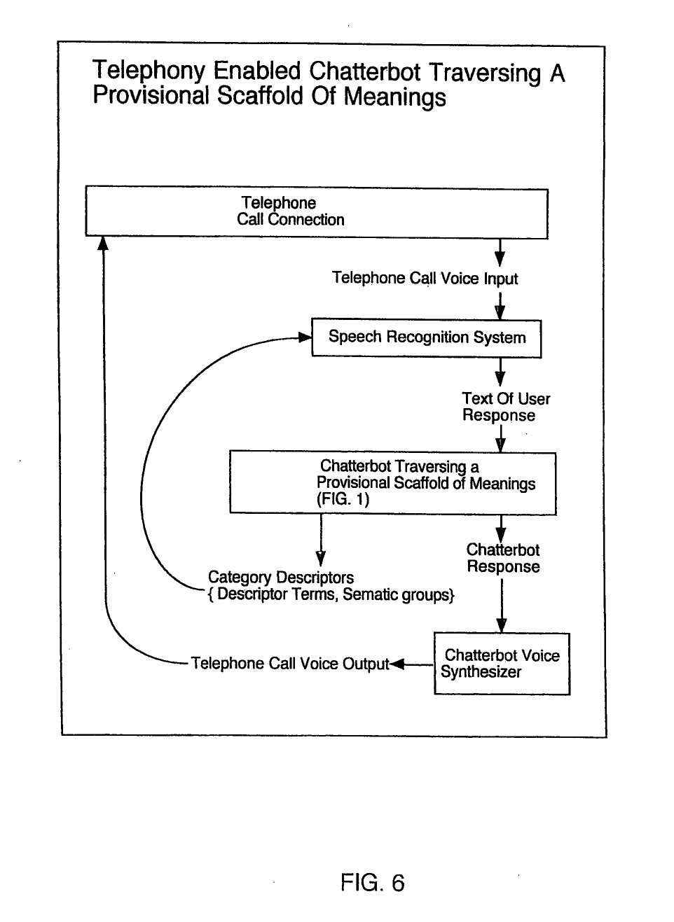

FIG. 6, according to one embodiment, shows an exemplary flowchart of a method of enhancing the chatterbot of FIG. 1 with a telephone connection to users. The telephone connection can be enabled by traditional voice-over-copper telephone line and analog call answering machine, or by a voice-over-IP internet phone connection such as provided by the Skype protocol, or a wireless cellphone or even a walkie-talkie protocol. Regardless, the Telephone Call Voice Input, coming from a user connected via the Telephone Call Connection, is converted to text via a Speech Recognition System. Any variation on Speech Recognition Systems can be used, although the most effective will employ at least some semantic input to vary the weight given candidate mappings of speech to text. For instance, U.S. patent application Ser. No. 10/329,402 shows how to more clearly disambiguate terminology. In addition, the method of FIG. 1 shows how to compute Category Descriptors. There are no Category Descriptors while performing Speech Recognition on the first user input, but all subsequent user inputs benefit from having a large set of Category Descriptor terms and Semantic Group Phrases which can be input to the Speech Recognition System to give preferential treatment to Category Descriptor terms and Semantic Group Phrases when performing Speech Recognition on user input. For example, a user may have input “cars” as a first user input. The Chatterbot Traversing a Provisional Scaffold of Meanings could then produce Category Descriptors which include “rental cars,” passed as input to the Speech Recognition System. If the user then inputs a mispronunciation of “ental cars” the Speech Recognition System could map there remaining phonemes to the preferred Category Descriptor of “rental cars,” even though the “r” is missing. Just like a person would understand from context what is said even when mispronounced, the method of FIG. 6 enables context, defined by the method of FIG. 1, to increase the accuracy of a Speech Recognition System, to improve telephony enabled chatterbots.

A telephony enabled chatterbot may implement the method of FIG. 1 in client-side locations such as the telephone or cellphone, as shown in FIG. 5, or in a more centralized location, such as shown in FIG. 6, in accordance with one embodiment. The present invention allows some or all of the method of FIG. 1 to be performed either at client-side, e.g., distributed locations, or at centralized locations, for implementation convenience and flexibility. After closing in on specific search results, categorical text quotes from web sites can be read aloud to cell-phone user, with options to automatically dial and connect to related phone numbers (not shown). To deliver other search results, text messages of related information can be sent to the user's cellphone (not shown).

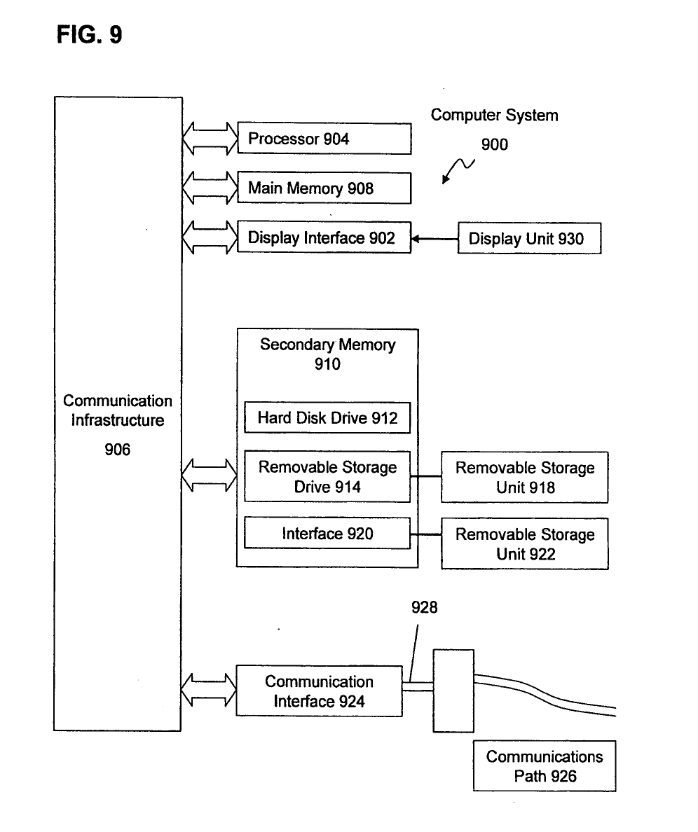

The present invention may be implemented using hardware, software, or a combination thereof and may be implemented in one or more computer systems or other processing systems. In one embodiment, the invention is directed toward one or more computer systems capable of carrying out the functionality described herein. An example of such a computer system 900 is shown in FIG. 9.

Computer system 900 includes one or more processors, such as processor 904. The processor 904 is connected to a communication infrastructure 906 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 900 can include a display interface 902 that forwards graphics, text, and other data from the communication infrastructure 906 (or from a frame buffer not shown) for display on a display unit 930. Computer system 900 also includes a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well-known manner. Removable storage unit 918, represents a floppy disk, magnetic tape, optical disk, etc., which is read by and written to removable storage drive 914. As will be appreciated, the removable storage unit 918 includes a computer usable storage medium having stored therein computer software and/or data.

In alternative embodiments, secondary memory 910 may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), or programmable read only memory (PROM)) and associated socket, and other removable storage units 922 and interfaces 920, which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928, which may be electronic, electromagnetic, optical or other signals capable of being received by communications interface 924. These signals 928 are provided to communications interface 924 via a communications path (e.g., channel) 926. This path 926 carries signals 928 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 914, a hard disk installed in hard disk drive 912, and signals 928. These computer program products provide software to the computer system 900. The invention is directed to such computer program products.

Computer programs (also referred to as computer control logic) are stored in main memory 908 and/or secondary memory 910. Computer programs may also be received via communications interface 924. Such computer programs, when executed, enable the computer system 900 to perform the features of the present invention, as discussed herein. In particular, the computer programs, when executed, enable the processor 910 to perform the features of the present invention. Accordingly, such computer programs represent controllers of the computer system 900.

In an embodiment where the invention is implemented using software, the software may be stored in a computer program product and loaded into computer system 900 using removable storage drive 914, hard drive 912, or communications interface 920. The control logic (software), when executed by the processor 904, causes the processor 904 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

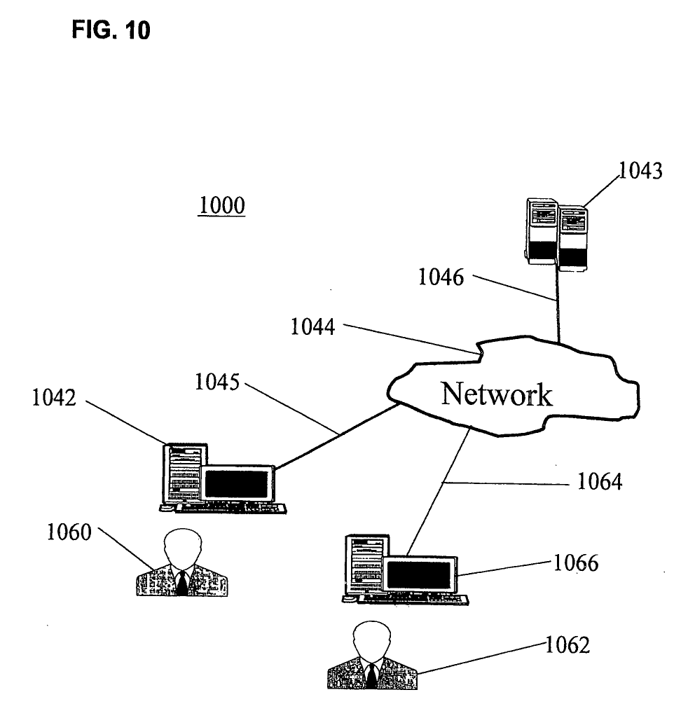

FIG. 10 shows a communication system 1000 usable in accordance with the present invention. The communication system 1000 includes one or more accessors 1060, 1062 (also referred to interchangeably herein as one or more “users”) and one or more terminals 1042, 1066. In one embodiment, data for use in accordance with the present invention is, for example, input and/or accessed by accessors 1060, 1064 via terminals 1042, 1066, such as personal computers (PCs), minicomputers, mainframe computers, microcomputers, telephonic devices, or wireless devices, such as personal digital assistants (“PDAs”) or a hand-held wireless devices coupled to a server 1043, such as a PC, minicomputer, mainframe computer, microcomputer, or other device having a processor and a repository for data and/or connection to a repository for data, via, for example, a network 1044, such as the Internet or an intranet, and couplings 1045, 1046, 1064. The couplings 1045, 1046, 1064 include, for example, wired, wireless, or fiberoptic links. In another embodiment, the method and system of the present invention operate in a stand-alone environment, such as on a single terminal.

While the present invention has been described in connection with preferred embodiments, it will be understood by those skilled in the art that variations and modifications of the preferred embodiments described above may be made without departing from the scope of the invention. Other embodiments will be apparent to those skilled in the art from a consideration of the specification or from a practice of the invention disclosed herein. It is intended that the specification and the described examples are considered exemplary only, with the true scope of the invention indicated by the following claims.

1. A method for outputting search results to a user via a user interface device, the method comprising:
receiving, via the user interface device, a user request having at least one part;
transmitting the user request to a responder for traversing a conversational scaffold and producing a document set in response to the user request;
transmitting the document set to a categorizer for producing one or more category descriptors;
transmitting the one or more category descriptors to a chatterbot response composer for producing a chatterbot response; and
outputting the chatterbot response via the user interface device.

2. The method of claim 1, further comprising:
parsing the user request into a plurality of useful clauses.

3. The method of claim 2, wherein each of the plurality of useful clauses includes a marker selected from a group consisting of a negation marker and an affirmation marker.

4. The method of claim 1, further comprising:
prior to transmitting the document set to the categorizer, inhibiting at least one of the one or more category descriptors.

5. The method of claim 1, wherein the document set includes at least one document, the method further comprising:
at the responder, using a semantic emotional path balancer for producing at least one of the at least one document in the document set.

6. The method of claim 1, wherein at least one part of the user request is input via a speech recognition system;
wherein the user interface device is controlled via a voice synthesizer; and
wherein the one or more category descriptors control the speech recognition system.

7. The method of claim 1, wherein the chatterbot response includes input from a conversational parser emotional path tracker and conversational empathic path response filter.

8. The method of claim 1, wherein the chatterbot response is output as text.

9. The method of claim 1, wherein the chatterbot response is output as sound via a speech synthesizer.

10. A system for outputting search results to a user via a user interface device, the system comprising:
means for receiving, via the user interface device, a user request having at least one part;
means for transmitting the user request to a responder for traversing a conversational scaffold and producing a document set in response to the user request;
means for transmitting the document set to a categorizer for producing one or more category descriptors;
means for transmitting the one or more category descriptors to a chatterbot response composer for producing a chatterbot response; and
means for outputting the chatterbot response via the user interface device.

11. The system of claim 10, further comprising:
means for inhibiting at least one of the one or more category descriptors prior to transmitting the document set to the categorizer.

12. The system of claim 10, wherein the document set includes at least one document, the system further comprising:
means for using a semantic emotional path balancer for producing at least one of the at least one document in the document set.

13. The system of claim 10, wherein at least one part of the user request is input via a speech recognition system;
wherein the user interface device is controlled via a voice synthesizer; and
wherein the one or more category descriptors control the speech recognition system.

14. The system of claim 10, wherein the chatterbot response includes input from a conversational parser emotional path tracker and conversational empathic path response filter.

15. The system of claim 10, wherein the chatterbot response is output as text.

16. The system of claim 10, wherein the chatterbot response is output as sound via a speech synthesizer.

17. A computer program product comprising a computer usable medium having control logic stored therein for causing a computer to output search results to a user via a user interface device, the control logic comprising:
first computer readable program code means for receiving, via the user interface device, a user request having at least one part;
second computer readable program code means for transmitting the user request to a responder for traversing a conversational scaffold and producing a document set in response to the user request;
third computer readable program code means for transmitting the document set to a categorizer for producing one or more category descriptors;
fourth computer readable program code means for transmitting the one or more category descriptors to a chatterbot response composer for producing a chatterbot response; and
fifth computer readable program code means for outputting the chatterbot response via the user interface device.

18. The computer program product of claim 17, wherein the document set includes at least one document, the control logic further comprising:
sixth computer readable program code means for using a semantic emotional path balancer for producing at least one of the at least one document in the document set.

19. The computer program product of claim 17, wherein at least one part of the user request is input via a speech recognition system;
wherein the user interface device is controlled via a voice synthesizer; and
wherein the one or more category descriptors control the speech recognition system.

20. The computer program product of claim 17, wherein the chatterbot response includes input from a conversational parser emotional path tracker and conversational empathic path response filter.
